(19) United States
(12) Patent Application Publication
(10) Pub. No.: US 2025/0126151 A1
(43) Pub. Date: Apr. 17, 2025

(54) TRANSPORT LAYER SECURITY (TLS) AUTHENTICATION BASED ON HASH OF EXPECTED CERTIFICATE

(71) Applicant: Telefonaktiebolaget LM Ericsson (publ), Stockholm (SE)

(72) Inventors: Daniel Migault, Montreal (CA); Miguel Angel Muñoz De La Torre Alonso, Madrid (ES)

(21) Appl. No.: 18/695,582

(22) PCT Filed: Nov. 24, 2021
(86) PCT No.: PCT/IB2021/060936

§ 371 Date: Mar. 26, 2024

(30) Foreign Application Priority Data
Sep. 28, 2021 (EP) 21382865.0

(51) Int. Cl. H04L 9/40; H04L 61/4511; H04W 12/069

(52) U.S. Cl. CPC H04L 63/166; H04L 61/4511; H04L 63/0823; H04W 12/069

(57) ABSTRACT

Systems and methods for Transport Layer Security (TLS) authentication based on a hash of an expected certificate are disclosed. In one embodiment, a method performed by a client application comprises obtaining one or more configuration parameters for establishing a TLS session between the client application and a trusted server application, the one or more configuration parameters. The method further comprises determining that an error has occurred based the one or more configuration parameters and, responsive to determining that the error has occurred, performing one or more actions that directly or indirectly trigger reinitialization of the one or more configuration parameters.

### RELATED APPLICATIONS

This application claims the benefit of European patent application serial number 21382865.0, filed Sep. 28, 2021, the disclosure of which is hereby incorporated herein by reference in its entirety.

### TECHNICAL FIELD

The present disclosure relates to Transport Layer Security (TLS) authentication.

### BACKGROUND

Today, there is a strong move for encrypting Domain Name System (DNS) exchanges for obvious privacy reasons. More specifically, encryption prevents a man-in-the-middle attack to intercept and read the DNS exchanges, which contain privacy-sensitive information, i.e., your web history. However, a man-in-the middle attack is only one type of attack. Accordingly, there is a need to ensure that the termination (e.g., DNS resolver) of the encrypted channel from the DNS client corresponds to the one chosen by the DNS client.

Network Operators (NOs), such as Mobile Network Operators (MNOs), should be able to provide or provision encrypted DNS resolvers in order to avoid a user's data being sent to third parties. This can be done by managing a Transport Layer Security (TLS) session between the User Equipment (UE) and the DNS resolver. Cloud providers and web browser providers are using the privacy argument to convince end users to switch from using the DNS resolver provided by their NO to a DNS resolver provided by the cloud provider. However, because there is trust in the NO network, there is a need to ensure that applications (e.g., cloud service applications and/or web browsers) cannot not overwrite user choices or NO configuration.

### SUMMARY

Systems and methods for Transport Layer Security (TLS) authentication based on a hash of an expected certificate are disclosed. In one embodiment, a method performed by a client application comprises obtaining one or more configuration parameters for establishing a TLS session between the client application and a trusted server application, the one or more configuration parameters comprising either: a certificate of the trusted server application, a hash of the certificate of the trusted server application, or a Pre-Shared Key (PSK). The method further comprises performing a TLS handshake procedure with a server application, wherein either: during the TLS handshake procedure the client application receives a certificate from the server application, or the TLS handshake procedure is performed with PSK authentication based on the PSK comprised in the one or more configuration parameters. The method further comprises determining that an error has occurred based on either: (a) a comparison of either (i) the certificate of the trusted server application comprised in the one or more configuration parameters and the certificate received from the server application during the TLS handshake or (ii) the hash of the certificate of the trusted server application and a computed hash of the certificate received from the server application during the TLS handshake; or (b) failed PSK authentication. The method further comprises, responsive to determining that the error has occurred, performing one or more actions that directly or indirectly trigger reinitialization of the one or more configuration parameters.

In one embodiment, the one or more configuration parameters comprise the hash of the certificate of the trusted server application, and the method further comprises computing a hash of the certificate received from the server application during the TLS handshake. Determining that the error has occurred comprises comparing the hash of the certificate of the trusted server application comprised in the one or more configuration parameters and the hash of the received certificate and determining that there is an error based on a result of comparing the hash of the certificate of the trusted server application comprised in the one or more configuration parameters and the hash of the received certificate. In one embodiment, the one or more configuration parameters comprise an Internet Protocol (IP) address associated to the trusted server application, an indication of a security protocol type, and a TLS for Authentication record (TLSA) that contains the hash of the certificate of the trusted server application. In one embodiment, the one or more configuration parameters further comprise a port number. In one embodiment, the one or more configuration parameters further comprise an authentication domain name.

In one embodiment, the method further comprises, responsive to determining that the error has occurred, aborting setup of the TLS session.

In one embodiment, performing one or more actions that directly or indirectly trigger reinitialization of the one or more configuration parameters comprises reporting a TLS error to a network node. In one embodiment, the method further comprises, responsive to reporting a TLS error to a network node, receiving a message comprising one or more re-initialized configuration parameters for establishing a TLS session between the client application and a trusted server application.

In one embodiment, performing one or more actions that directly or indirectly trigger reinitialization of the one or more configuration parameters comprises sending, to a network node, a message for modification of the IP connectivity session that comprises an indication of a request for re-initialization of the one or more configuration parameters for establishing a TLS session between the client application and a trusted server application.

In one embodiment, the client application is a Domain Name System (DNS) client, and the server application is a DNS resolver.

In one embodiment, the client application is implemented on a wireless communication device for a cellular communications system, and obtaining the one or more configuration parameters comprises obtaining the one or more configuration parameters from a network node in a core network of the cellular communications system. In one embodiment, the cellular communication system is either a Fifth Generation System (5GS) or an Evolved Packet System (EPS).

Corresponding embodiments of a communication device that includes a client application are also disclosed. In one embodiment, a communication device that includes a client application comprises processing circuitry configured to cause the communication device to obtain one or more configuration parameters for establishing a TLS session between the client application and a trusted server application, the one or more configuration parameters comprising either: a certificate of the trusted server application, a hash of the certificate of the trusted server application, or a PSK. The processing circuitry is further configured to cause the communication device to execute the client application such that the client application performs a TLS handshake procedure with a server application, wherein either: during the TLS handshake procedure, the client application receives a certificate from the server application, or the TLS handshake procedure is performed with PSK authentication based on the PSK comprised in the one or more configuration parameters. The processing circuitry is further configured to cause the communication device to execute the client application such that the client application determines that an error has occurred based on either: (a) a comparison of either: (i) the certificate of the trusted server application comprised in the one or more configuration parameters and the certificate received from the server application during the TLS handshake or (ii) the hash of the certificate of the trusted server application and a computed hash of the certificate received from the server application during the TLS handshake; or (b) failed PSK authentication. The processing circuitry is further configured to cause the communication device to execute the client application such that the client application to, responsive to determining that the error has occurred, perform one or more actions that directly or indirectly trigger reinitialization of the one or more configuration parameters.

In one embodiment, a method performed by a client application comprises obtaining one or more configuration parameters for establishing a TLS session between the client application and a trusted server application, the one or more configuration parameters comprising either: a certificate of the trusted server application or a hash of the certificate of the trusted server application. The method further comprises performing a TLS handshake procedure with a server application during which the client application receives a certificate from the server application and determining that the server application from which the certificate is received during the TLS handshake is the trusted server application based on a comparison of either: (i) the certificate of the trusted server application comprised in the one or more configuration parameters and the certificate received from the server application during the TLS handshake or (ii) the hash of the certificate of the trusted server application and a computed hash of the certificate received from the server application during the TLS handshake. The method further comprises, responsive to determining that the server application from which the certificate is received during the TLS handshake is the trusted server application, proceeding with setup of the TLS session. The method further comprises performing a TLS handshake for establishment of a subsequent TLS session associated to the same IP connectivity session using a mechanism that ensures that the subsequent TLS session is established to the same trusted server application at that to which the TLS session is established.

In one embodiment, the mechanism is either TLS session resumption based on a PSK or PSK Elliptic-Curve Diffie-Hellman Exchange (PSK-ECDHE) authentication or a TLS handshake using Elliptic-Curve Diffie-Hellman Exchange (ECDHE) authentication.

Embodiments of a method performed by a first network node in a core network of a cellular communications system are also disclosed herein. In one embodiment, a method performed by a first network node in a core network of a cellular communications system comprises receiving, from a second network node, a message that comprises one or more rules to be implemented by the first network node to detect a TLS error reported by a wireless communication device within traffic for an existing TLS connection between a DNS client at the wireless communication device and a DNS resolver. The method further comprises detecting a TLS error reported by the wireless communication device using the one or more rules and, responsive to detecting the TLS error, sending a message to the second network node that comprises an indication of a request to re-initialize one or more DNS parameters configured to the wireless communication device.

In one embodiment, the cellular communications system (300) is a 5GS, the first network node is a User Plane Function (UPF), and the second network node is a Session Management Function (SMF). Receiving the message that comprises the one or more rules comprises receiving, from the SMF (500), a Packet Forwarding Control Protocol (PFCP) Session Establishment Request comprising the one or more rules, and sending the message comprises sending a PFCP report request message to the SMF, wherein the PFCP report request message comprises the indication of the request to re-initialize the one or more DNS parameters configured to the wireless communication device.

In another embodiment, a method performed by a first network node in a core network of a cellular communications system comprises sending, to a second network node, a message that comprises one or more rules to be implemented by the second network node to detect a TLS error reported by a wireless communication device within traffic for an existing TLS connection between a DNS client at the wireless communication device and a DNS resolver. The method further comprises receiving a message from the second network node that comprises an indication of a request to re-initialize one or more DNS parameters configured to the wireless communication device and, responsive to receiving the message, triggering an Internet Protocol (IP) session modification procedure for re-initializing one or more DNS parameters configured to the wireless communication device.

In one embodiment, the cellular communications system is a 5GS, the first network node is a SMF, and the second network node is a UPF. Sending the message that comprises the one or more rules comprises sending, to the UPF, a PFCP Session Establishment Request comprising the one or more rules, and receiving the message comprises receiving a PFCP report request message from the UPF, wherein the PFCP report request message comprises the indication of the request to re-initialize the one or more DNS parameters configured to the wireless communication device. Triggering the IP session modification procedure for re-initializing the one or more DNS parameters configured to the wireless communication device comprises triggering a Protocol Data Unit (PDU) session modification procedure for re-initializing the one or more DNS parameters configured to the wireless communication device.

Corresponding embodiments of network nodes are also disclosed herein.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a system 100 that enables Transport Layer Security (TLS) authentication and TLS error handling in accordance with embodiments of the present disclosure;

FIGS. 2A and 2B illustrate a procedure for establishment of an initial TLS session between a client application at a communication device and a server application at a network node as well as TLS error handling and establishment of subsequent TLS session(s), in accordance with embodiments of the present disclosure;

FIG. 3 illustrates one example of a cellular communications system in which some embodiments of the present disclosure may be implemented;

FIGS. 4A and 4B illustrate a procedure for initial TLS session setup and TLS error handling as well as TLS error handling and establishment of subsequent TLS session(s) in association with a Domain Name System (DNS) resolution service, in accordance with some embodiments of the present disclosure;

FIG. 5 illustrates a procedure in which the DNS client reports a TLS error to the network, the network detects the reported TLS error, and the network node then performs a procedure by which the configuration parameters are renegotiated, in accordance with one example embodiment of the present disclosure;

FIG. 6 illustrates an alternative procedure to that of FIG. 5 where, instead of the DNS client triggering a TLS error message, the DNS client requests a modem of the WCD to trigger a User Equipment (UE) Initiated Protocol Data Unit (PDU) Session Modification procedure to thereby indicate to the network to re-initialize the DNS parameters, in accordance with another example embodiment of the present disclosure;

FIG. 7 is a flow chart that illustrates the operation of the DNS resolver 314 in accordance with one example embodiment of the present disclosure;

FIGS. 8, 9, and 10 are schematic block diagrams of example embodiments of a network node; and

FIGS. 11 and 12 are schematic block diagrams of example embodiments of a wireless communication device.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Today, Domain Name System (DNS) resolutions are performed by an authenticated DNS resolver in order to improve end user's privacy. While this represents an improvement on the end user's privacy, little attention is being provided to ensure that the authenticated DNS resolver matches the choice of the end user. Currently, when communication device requests the support of encrypted DNS, the communication device obtains the necessary configuration parameters (IP address and TLS parameters) from the network to set the encrypted session (i.e., the Transport Layer Security (TLS) session) with the DNS resolver. The necessary configuration parameters for the TLS session are generally provided from the network to the communication device during establishment of an Internet Protocol (IP) connectivity session (e.g., during Protocol Data Unit (PDU) session establishment in a 3GPP 5GS or during IP connectivity session establishment in a 3GPP EPS). Each TLS session to the DNS resolver is based on these configuration parameters. Thus, the current solution assumes that the configuration parameters have not been changed by any parties. Thus, the existing solution consists of provisioning configuration parameters and having the DNS client us them each time a TLS session is needed. This solution puts a lot of trust into the configuration parameters and requires these configuration parameters to remain relatively static. However, it is quite possible that these configurations parameters may be changed at the device, e.g., via an attack or otherwise, such that TLS sessions are subsequently established to a DNS resolver other than that configured by the network/NO/MNO/ISP.

Systems and methods are disclosed herein that address the aforementioned and/or other issues related to existing DNS resolution solutions. Note, however, that while some of the embodiments described herein are described with respect to DNS resolution, embodiments of the solutions described herein are not limited to DNS resolution and may be used with respect to TLS sessions established between any two endpoints.

In some embodiments, systems and methods are provided that relate to a DNS resolver (e.g., provided by a network, Network Operator (NO), or Internet Service Provider (ISP)) that is authenticated using TLS authentication and a corresponding DNS client. Embodiments are disclosed herein that increases the probability that the DNS resolver used by the DNS client for an initial TLS session and any subsequent TLS session(s) associated to the same IP connectivity session is the same DNS resolver configured by the network/NO/ISP when the IP connectivity session is established. In other words, embodiments of the present disclosure increase the probability that network parameters configured by the network/NO/ISP are not changed by a third-party application during the lifetime of the IP connectivity session. Embodiments are disclosed herein related to mechanisms that are enforced on the DNS client as well as mechanisms that are enforced by the DNS resolver. These mechanisms include any one or more of the following mechanisms:
In some embodiments, a mechanism that provides an efficient way (in term of number of bytes) to configure a TLS client for TLS authentication is provided. More specifically, in one embodiment, a hash of the expected TLS certificate (i.e., a hash of the TLS certificate of the expected DNS resolver) is provided to the communication device, as opposed to a full chain of certificate. In one embodiment, the hash of the expected TLS certificate of the DNS resolver is provided to the communication device in association with (e.g., during) a procedure for establishing the IP connectivity session. For example, for a 3GPP 5GS, the hash of the TLS certificate of the expected DNS resolver is provided to the UE during PDU session establishment (e.g., via a new parameter).
In some embodiments, a mechanism is provided that details how further TLS sessions associated to the same IP connectivity session are established in order to provide sufficient guarantee that these further TLS sessions remain established with the original DNS resolver.
In some embodiments, a mechanism is provided that handles TLS errors and instructs the network to reconfigure IP connectivity session (e.g., reconfigure the PDU session in case of 3GPP 5GS) when a TLS error occurs. Note that such mechanism may be used as a way to manage TLS errors that occurs with a service provided by the network. Introduction of TLS for DNS resolution service is relatively new and hot line calls are costly.
In some embodiments, configurations to specify the behavior upon TLS error are provided. In one embodiment, this includes the definition of new extensions in the Packet Forwarding Control Protocol (PFCP).

While not being limited by or to any particular advantages, embodiments of the solutions described herein provide advantages over the existing solutions. These advantages include one or more of the following advantages:
Embodiments disclosed herein may allow the network/NO/MNO/ISP to ensure that the choice of DNS resolver by the communication device (e.g., UE) defined at the initialization of the IP connectivity session remains through the lifetime of the IP connectivity session (e.g., avoiding changes by a third-party application or protects the end user from an active attacker changing the communication device settings).
Embodiments disclosed herein may allow the network/NO/MNO/ISP to support an efficient way (in term of number of bytes) to configure a TLS client.
Embodiments disclosed herein may allow the network/NO/MNO/ISP to support a mechanism to reconfigure the IP connectivity session when a TLS error occurs.

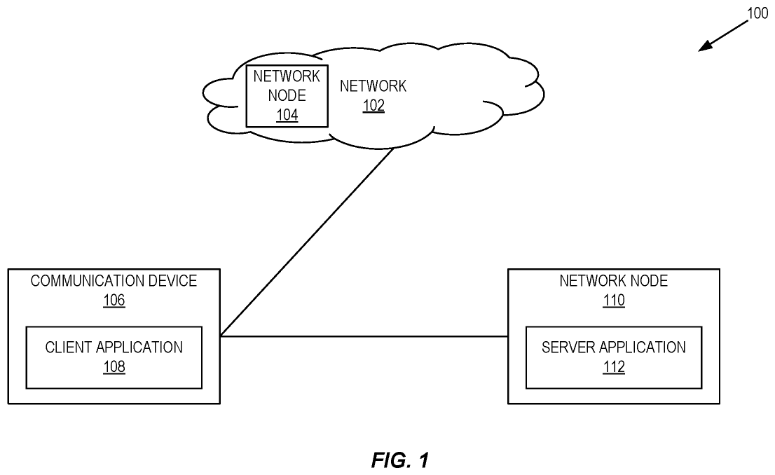

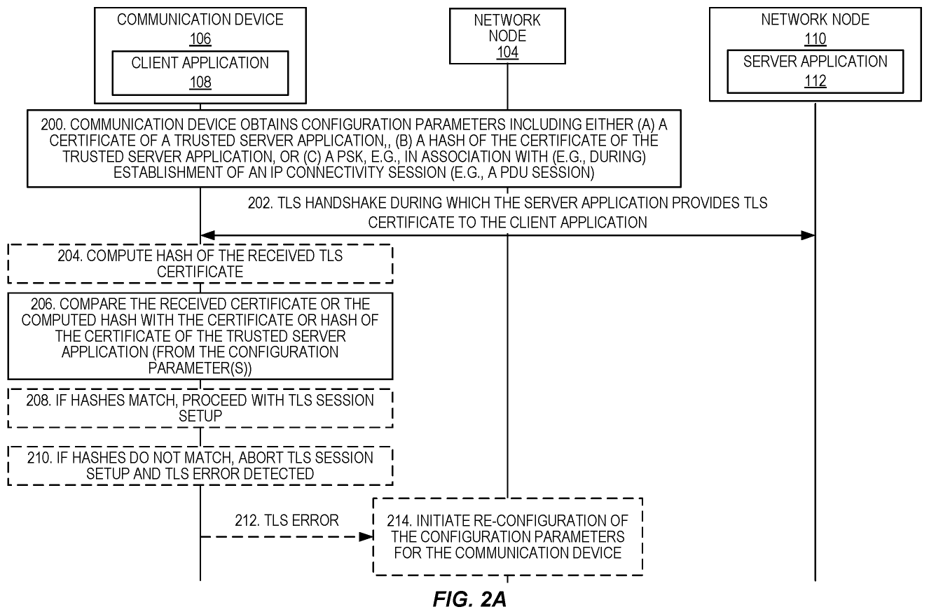

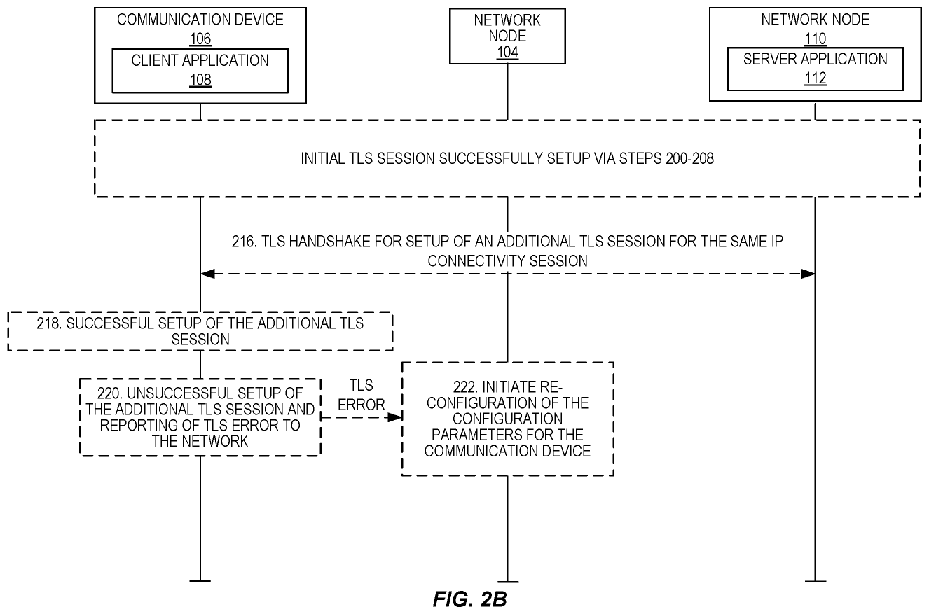

In this regard, FIG. 1 illustrates a system 100 that enables TLS authentication and TLS error handling in accordance with embodiments of the present disclosure. As illustrated, the system 100 includes a network 102 including one or more network nodes 104, a communication device 106 that includes a client application 108, and a network node 110 that includes a server application 112. As described in the detailed example embodiments below, in one embodiment, the client application 108 is a DNS client, and the server application 112 is a DNS resolver; however, the present disclosure is not limited thereto. The client application 108 and the server application 112 may be for other types of services for which TLS authentication is desired. FIGS. 2A and 2B illustrate a procedure for establishment of an initial TLS

session between the client application 108 at the communication device 106 and the server application 112 at the network node 110 as well as TLS error handling and establishment of subsequent TLS session(s), in accordance with embodiments of the present disclosure. Optional steps are represented by dashed lines/boxes. As illustrated, the communication device 106 obtains configuration parameters for TLS session setup from the network 102 (e.g., from a network node 104) (step 200). In one embodiment, the configuration parameters are obtained in association with (e.g., during) a procedure for establishment of an associated IP connectivity session between the communication device 106 and the network 102. For example, in an embodiment in which the system 100 is a 3GPP 5GS, the IP connectivity session is a PDU session, and the configuration parameters are obtained by the communication device 106 from the network 102 during PDU session establishment. As another example, in another embodiment, the system 100 is a 3GPP EPS, the IP connectivity session is an IP-Connectivity Access Network (IP_CAN) session, and the communication device 106 obtains the configuration parameters from the network 102 during PDN session/connection establishment.

In one embodiment, the configuration parameters for TLS session setup include either: (a) a TLS certificate of a trusted (or expected) server application (e.g., a trusted DNS resolver) or (b) a hash of the TLS certificate of the trusted server application. In the example of FIG. 1, the trusted server application is the server application 112 at the network node 110. In one embodiment, the hash of the TLS certificate of the trusted server application, rather than the full chain of certificate, is included in the configuration parameters. In this manner, the size of the configuration parameters in terms of number of bytes of data is substantially reduced. The configuration parameters for TLS session may further include one or more other parameters such as, e.g., an IP address associated to the server application 112 at the network node 110, security protocol type, etc.). However, in another embodiment, the one or more configuration parameters includes a Pre-Shared Key (PSK) to be used for PSK authorization in association with TLS session setup between the client application 108 and the server application 112 such that PSK authorization, and thus TLS setup, will fail if the PSK included in the configuration parameters does not match a respective PSK of the server application 112 (i.e., PSK authorization will not succeed unless the server application 112 is the trusted server application).

Until otherwise noted, the remainder of the discussion of FIGS. 2A and 2B is directed to an embodiment in which the one or more configuration parameters include either: (a) a TLS certificate of a trusted (or expected) server application (e.g., a trusted DNS resolver) or (b) a hash of the TLS certificate of the trusted server application. Sometime after obtaining the configuration parameters in step 200, when the client application 108 at the communication device 106 desires to setup an initial TLS session for communication with the server application 112 at the network node 110, the client application 108 and the server application 112 perform a TLS handshake procedure during which the client application 108 receives a TLS certificate of the server application 112 (step 202). In one embodiment, the configuration parameters include the hash of the TLS certificate of the trusted server application and, as such, the client application 108 computes a hash of the received TLS certificate for comparison to the hash of the TLS certificate included in the configuration parameters (step 204). The client application 108 determines whether the server application 112 from which the TLS certificate is received is the trusted server application based on a comparison of the received certificate from step 202 or the computed hash from step 204 to certificate or hash included in the configuration parameters received in step 200 (step 206). If the server application 112 with which the TLS handshake is performed is verified as the trusted (i.e., expected) server application (e.g., if the two hashes match), the TLS authentication is a success and communication between the client application 108 and the server application 112 over the established TLS session is performed (step 208). However, if the server application 112 with which the TLS handshake is performed is not verified as the trusted (i.e., expected) server application (e.g., if the two hashes to not match), establishment of the TLS session is aborted and a TLS error is detected (step 210). Once the TLS error is detected, the client application 108 performs one or more actions that directly or indirectly trigger re-initialization of the configuration parameters. In this example embodiment, if a TLS error is detected, the communication device 106 reports the detected TLS error to the network 102 (e.g., to the network node 104 in the illustrated example) (step 212) and, in response, the network 102 initiates a procedure by which the configuration parameters for TLS session setup are re-initialized (also referred to herein as “reconfigured”) at the communication device 106 (step 214). Steps 212 and 214 may be desired in order to avoid a hard fail (e.g., the communication device 110 is unable to connect to the network) in the case where there is a TLS error.

Assuming that TLS authentication was successful, in one embodiment, one or more additional TLS sessions between the client application 108 and the server application 112 may subsequently be desired. In one embodiment, in order to establish an additional TLS session (e.g., associated to the same IP connectivity session as the initial TLS session above), rather than using the configuration parameters, the client application 108 utilizes TLS handshake mechanism that relies on a secret obtained by the client application 108 during setup of the initial TLS session such that setup of the additional TLS session will only be successful if the server application 112 is the same as that to which the initial TLS session was established (step 216). As discussed below, in one example embodiment, setup of the additional TLS session utilizes a session resumption mechanism defined in, e.g., TLS 1.3 based on a Pre-Shared Key (PSK) or PSK-Elliptic-Curve Diffie-Hellman Exchange (ECDHE) authentication. As understood by those of skill in the art, the PSK or PSK-ECDHE is obtained during setup of the initial TLS session above and is used for TLS authentication during a modified TLS handshake (i.e., a TLS handshake for session resumption). In another example embodiment, the TLS handshake for the additional TLS session uses ECDHE authentication. Because the TLS handshake for the additional TLS session relies on a secret obtained during the initial TLS session setup, TLS authentication for the additional TLS session will only succeed if the server application 112 is the same as that to which the initial TLS session was established (step 218). Otherwise, TLS authentication will fail and a TLS error will be detected, which in turn will trigger a TLS error report to the network 102 (step 220). The network will then perform a network-triggered re-initialization of the configuration parameters for TLS session setup (step 222).

Before proceeding a description of an alternative embodiment in which the configuration parameters of step 200 include a PSK. In this case, in step 202, the TLS handshake procedure uses PSK authentication (and as such the certificate may not be provided to the client application 108 during the TLS handshake). If the server application 112 is the trusted server application, PSK authentication will succeed. Otherwise, PSK authentication, and thus TLS session setup, will fail. If PSK authentication fails, the client application 108 detects a TLS error and may send a notification of the TLS error to the network node, e.g., in step 212, which in turn may trigger the network to re-initialize the configuration parameters, as described above.

Now, the description will turn to specific example embodiments related to an authenticated DNS resolver and a DNS client. Further, in these example embodiments, the authenticated DNS resolver and the DNS client are implemented in the context of a 3GPP 5GS. However, it is to be understood that the following embodiments are not limited to a 3GPP 5GS but may be utilized in other types of 3GPP systems (e.g., EPS) and/or in other types of communication systems (e.g., an ISP network).

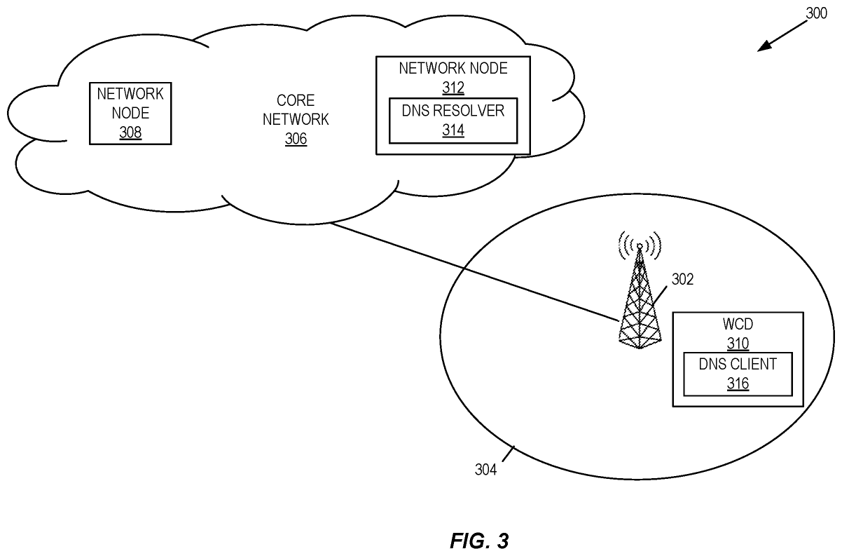

In this regard, FIG. 3 illustrates an example of a 5GS system 300 in which embodiments of the present disclosure may be implemented. The 5GS 300 includes a Next Generation RAN (NG-RAN) including a base station 302, which in the 5GS is referred to as a NR base stations (gNBs), controlling a corresponding cell(s) 304. The 5GS 300 also includes a core network 306, which in the 5GS 300 is referred to as the 5GC. As will appreciated by one of ordinary skill in the art, the core network 306 includes numerous core network nodes 308, or Network Functions (NFs), such as, e.g., an AMF, SMF, UPF, PCF, etc. The base station 302 is connected to the core network 306. The base station 302 provides service to a wireless communication device(s) 310 in the corresponding cell 304. In the following description, the wireless communication device 310 is oftentimes a UE and as such sometimes referred to herein as a UE 310, but the present disclosure is not limited thereto.

In accordance with one embodiment of the present disclosure, the 5GS 300 also includes a network node 312 that hosts or otherwise implements a DNS resolver 314. In the illustrated example, the network node 312 is illustrated as part of the core network 306; however, the present disclosure is not limited thereto. Further, a DNS client 316 is implemented on the wireless communication device 310.

In the following, an initial, or first (in time), TLS session between a DNS client and a DNS resolver is performed in such a way that it is guaranteed that the DNS resolver is the expected (legitimate or trusted) DNS resolver. Then, rather than relying on the same configuration parameters when establishing subsequent TLS sessions associated to the same PDU session, other mechanism (e.g., TLS session resumption procedure) is performed to ensure that the subsequent TLS sessions are established with the same (legitimate) DNS resolver. This strategy is referred to herein as Trust On First Use (TOFU).

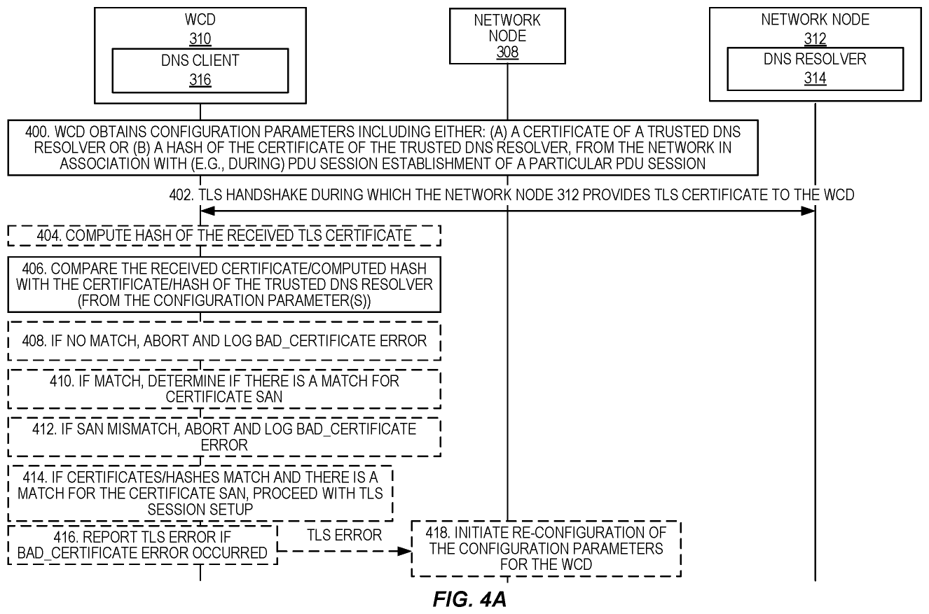

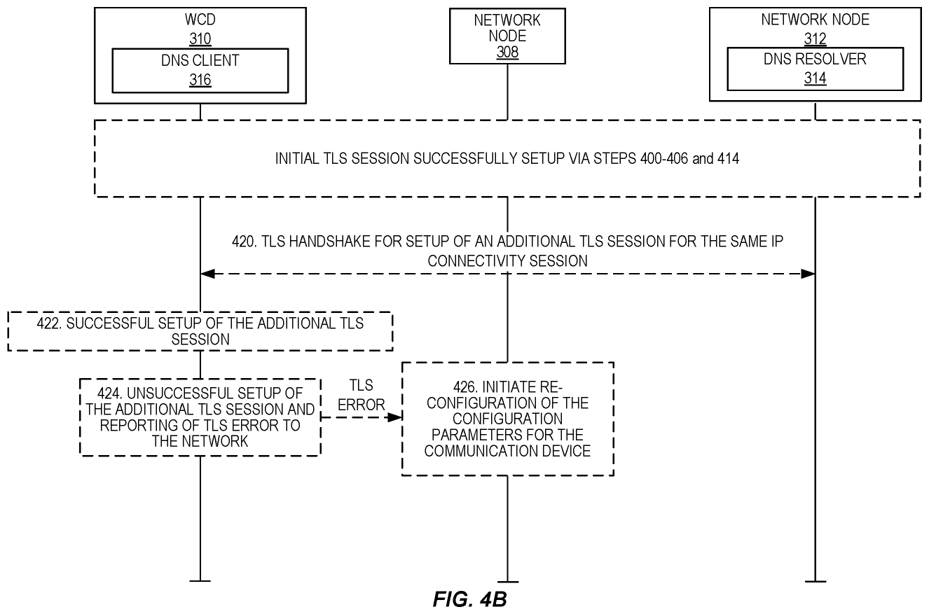

FIGS. 4A and 4B illustrate a procedure for initial TLS session setup and TLS error handling as well as TLS error handling and establishment of subsequent TLS session(s) in association with a DNS resolution service, in accordance with embodiments of the present disclosure. Optional steps are represented by dashed lines/boxes. Note that while not described with respect to FIGS. 4A and 4B, the alternative embodiment described above in which the configuration parameters include a PSK are also applicable here. Note that the initial TLS session is assumed to have more trust than a TLS session established a few hours later because the TLS session may be triggered by the entity receiving the provisioning information, in which cases information stored on the SSD are not considered. However, for the initial TLS session, the time between receipt of the configuration parameters from the network and use of the configuration parameters by the DNS client 316 is very short and, as such, the configuration parameters have only a very limited amount of exposure to potential attacks at that point in time.

As illustrated, the wireless communication device (WCD) 310 obtains configuration parameters for TLS session setup from a network node 308 in association with (e.g., during) a PDU session establishment procedure of a particular PDU session (step 400). The configuration parameters for TLS session setup include either: (a) a TLS certificate of an expected, or trusted, DNS resolver or (b) a hash of the TLS certificate of the expected, or trusted, DNS resolver. In one embodiment, the hash of the TLS certificate, rather than the full chain of expected certificate, is included in the configuration parameters. In this manner, the size of the configuration parameters in terms of number of bytes of data is substantially reduced. The configuration parameters for TLS session may further include one or more other parameters such as, e.g., an IP address of the DNS resolver 314 or the network node 312, security protocol type, etc.).

More specifically, in one embodiment, if the IP address of the DNS resolver 314 is public and the DNS resolver 314 has a public certificate (e.g., X.509 certificate) with the IP address of the DNS resolver 314 appearing in the SubjectAtName or similar field, the network node 308 sends the DNS client 316 at the WCD 310 the following configuration parameters:
the IP address of the DNS resolver XX114, e.g., in a IPV6 Address or DNS Server IPV4 Address container,
DNS Server Security Information (DSSI) security protocol type,
the DSSI TLS for Authentication record (TLSA), which contains the hash of the expected certificate, and
optionally the DSSI port number.
   Note that DSSI is configurations specified in Internet Engineering Task Force (IETF) RFCs such as, e.g., credentials to authenticate a DNS server, supported security mechanisms, port number, etc.

In one embodiment, if the DNS resolver 314 does not have a public IP address and a certificate (e.g., a X509 certificate) associated the DNS resolver 314 has a subjectAtName or similar field that contains an authoritative domain name, the network node 308 sends the DNS client 316 at the WCD 310 the following configuration parameters:
the IP address of the DNS resolver 314, e.g., in a IPV6 Address or DNS Server IPv4 Address container,
the DSSI security protocol type,
the DSSI TLSA, which contains the hash of the expected certificate,
the DSSI authentication domain name, and
optionally the DSSI port number.

Note also that SPKI [RFC7469] could alternatively be used to carry the hash of the expected certificate.

Sometime thereafter, when the WCD 310 desires to setup an initial TLS session for communication between the DNS client 316 and the DNS resolver 314 at the network node 312, the WCD 310 and the network node 312 perform a TLS handshake procedure during which the WCD 310 receives a TLS certificate of the DNS resolver 314 (step 402). More specifically, the DNS client 316 on the WCD 310 derives the DNS resolver 314 from the DNS Server IP address (e.g., the IPV6 Address or DNS Server IPV4 Address) contained in the received configuration parameters. The DNS client 316 derives the port from the port number parameter and, when not explicitly specified, the DNS client 310 uses the default port specified by the security protocol. For the TLS handshake, the DNS client 316 starts the TLS session with the IP address and port and, during the TLS handshake, receives the TLS certificate of the DNS resolver 314.

In one embodiment, the WCD 310 computes a hash of the received TLS certificate (step 404). The WCD 310 determines whether the DNS server 114 is authenticated (i.e., determines whether the DNS resolver 114 is the expected DNS resolver) based on a comparison of the received certificate or the computed hash and the certificate or hash included in the configuration parameters (e.g., in the DSSI TLSA) in step 400 (step 406). If there is not a match (i.e., if there is a mismatch between the two certificates/hashes), the TLS handshake is aborted with a “bad_certificate” error (step 408). In addition, if a DSSI authentication domain has been provided in the configuration parameters, the DNS client 316 checks that the provided DSSI authentication domain matches the certificate Subject Alternative Name (SAN); otherwise, the DNS client XX116 determines whether the certificate SAN matches the DNS Server IPv4/6 Address (step 410). If a mismatch occurs, the TLS handshake is aborted with a “bad_certificate” error (step 412). If there is a match between the two certificates/hashes and if there is a match between either the provided DSSI authentication domain and the certificate SAN or a match between the certificate SAN and the DNS Server IPv4/6 Address, the TLS authentication is a success (i.e., the TLS session is set) and communication between the DNS client 316 and the DNS resolver 314 over the established TLS session is performed (step 414). Note that the matching of the SAN in step 410 is optionally performed to check coherence with other configuration parameters, but this could be considered as additional checks given that the hash is provided in a secure way and the hash match should be sufficient.

In one embodiment, if a bad_certificate error is returned, this event is logged and an alert is raised to the ISP for further investigation as the WCD 310 is considered to be unable to connect to the Internet.

In one embodiment, if a bad_certificate error is returned, the WCD 310 determines that there is a TLS error and reports this TLS error to the network (e.g., to the network node 308 in the illustrated embodiment) (step 416). In response, the network (e.g., the network node 308) initiates a procedure by which the configuration parameters for TLS session setup are re-configured at the WCD 310 (step 418).

Assuming that TLS authentication was successful, in one embodiment, one or more additional TLS sessions between the DNS client 316 and the DNS resolver 314 may subsequently be desired. In one embodiment, in order to establish an additional TLS session associated to the same PDU session as the initial TLS session above, rather than using the configuration parameters, the DNS client 316 utilizes a TLS handshake mechanism that relies on a secret obtained by the DNS client 316 during setup of the initial TLS session such that setup of the additional TLS session will only be successful if the DNS resolver 314 is the same as that to which the initial TLS session was established (step 420). As discussed below, in one example embodiment, setup of the additional TLS session utilizes a session resumption mechanism defined in, e.g., TLS 1.3 based on a Pre-Shared Key (PSK) or PSK-Elliptic-Curve Diffie-Hellman Exchange (ECDHE) authentication. As understood by those of skill in the art, the PSK or PSK-ECDHE is obtained during setup of the initial TLS session above and is used for TLS authentication during a modified TLS handshake (i.e., a TLS handshake for session resumption). In another example embodiment, the TLS handshake for the additional TLS session uses ECDHE authentication. Because the TLS handshake for the additional TLS session relies on a secret obtained during the initial TLS session setup, TLS authentication for the additional TLS session will only succeed if the DNS resolver 314 is the same as that to which the initial TLS session was established (step 422). Otherwise, TLS authentication will fail and a TLS error will be detected, which in turn will trigger a TLS error report to the network 102 (step 424). The network will then perform a network-triggered re-initialization of the configuration parameters for TLS session setup (step 426).

FIGS. 4A and 4B illustrates some examples of TLS errors that may occur during the TLS handshake. However, other errors during the TLS handshake are also problematic as the DNS client XX110 may be in an offline state and not be able to connect to the Internet. As a result, any TLS error should preferably be monitored. However, these TLS errors do not normally result in the configuration parameters being re-configured, or reset, by the network.

In one embodiment, when a TLS session cannot be set, a renegotiation of the configuration parameters associated to the DNS resolver 314 is performed. Such negotiation may be initiated (and optionally performed) by the DNS client 316 or the DNS resolver 314. In one embodiment, once initiated, the renegotiation of the configuration parameters is performed by the network upon the receipt of a report of a TLS error from the DNS client 316 or the DNS resolver 314.

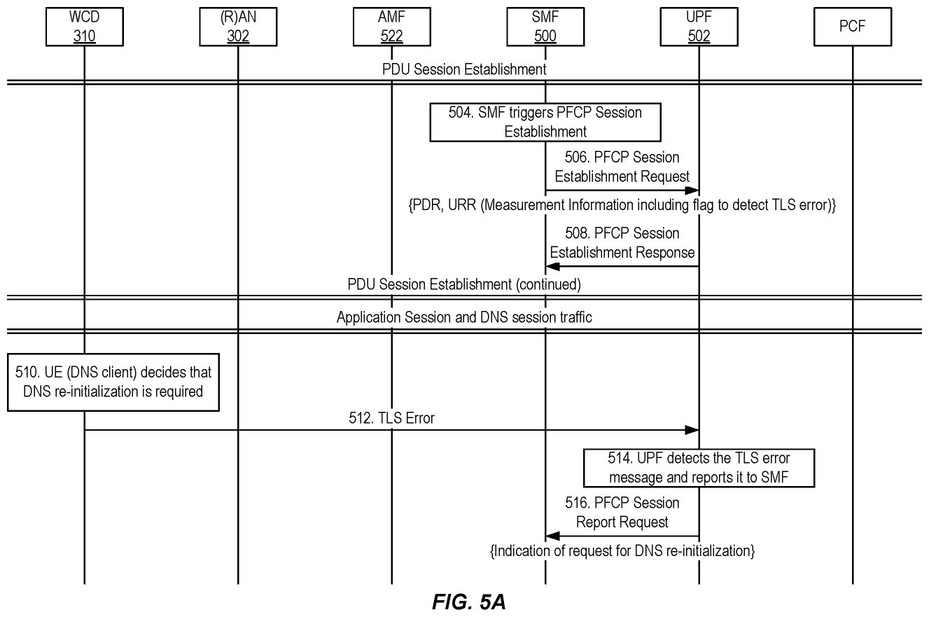

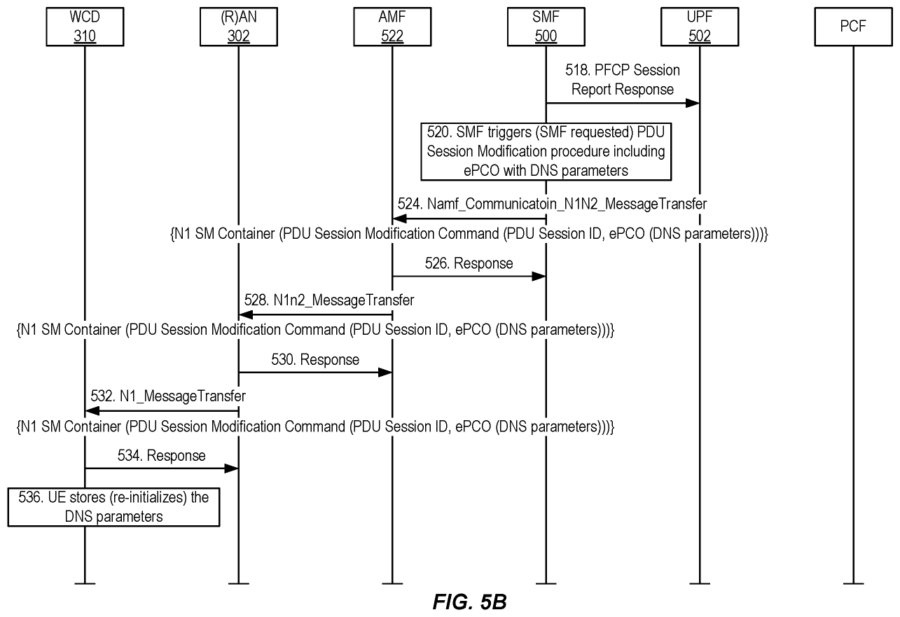

As discussed above, in the event of a TLS error, reinitialization of the configuration parameters associated with the DNS resolver 314 is desired. In this regard, FIG. 5 illustrates a procedure in which the DNS client 316 reports a TLS error to the network, the network detects the reported TLS error, and the network node then performs a procedure by which the configuration parameters are renegotiated, in accordance with one example embodiment of the present disclosure. In this example, the configuration parameters are renegotiated via a PDU session modification procedure. However, examples of other procedures that could be used instead are network initiated PDU Session Modification, PDU Session Release and PDU Session Establishment at the WCD 310 or network triggered PDU Session Establishment. Also note that current 3GPP specifications limit PDU session modification to Quality of Service (QoS) modifications. Thus, embodiments of the present disclosure extend PDU session modification to further enable reinitiating DNS parameters. Also note that PDU Session Modification can be triggered by the WCD 310 or by the network. In order to limit the complexity on the DNS client side, in the preferred embodiment illustrated in FIG. 5, the DNS client 310 triggers the network to initiate PDU session modification by sending a TLS error. In general, a TLS error indicates that the TLS session cannot be setup properly and that the PDU session needs to be reconfigured. In some cases, a specific error might be considered, but these TLS errors may also be implementation dependent. For that reason, the term “TLS error” is used to cover these variations.

As illustrated in FIG. 5, for an established PDU session (e.g., the PDU session established via the PDU session establishment procedure of step 400 of FIG. 4), an associated SMF 500 triggers a PFCP session establishment towards a UPF 502 associated with the PDU session by sending a PFCP Session Establishment Request message, including PDRs/FARs/QERs/URRs, specifically by including a PDR to detect DNS traffic and an associated URR, which is proposed to request detection and reporting of a specific TLS error message which indicates that re-initialization of the configuration parameters associated with DNS resolution is needed (steps 504 and 506). In one embodiment, the Measurement Information in the Create/Update URR is updated as follows:

Modified version of Table 7.5.2.4-1 from 3GPP TS 29.244:
Create URR IE within PFCP Session Establishment Request

| | | | | | | | |
|---|---|---|---|---|---|---|---|
| Measurement | C | This IE shall be included if any of the following | — | X | X | X | Measurement |
| Information | | flag is set to “1”. | | | | | Information |
| | | Applicable flags are: | | | | | |
| | | Measurement Before QoS | | | | | |
| | | Enforcement Flag: this flag shall be set to “1” if | | | | | |
| | | the traffic usage before any QoS Enforcement is | | | | | |
| | | requested to be measured. | | | | | |
| | | Inactive Measurement Flag: this flag | — | X | — | X | |
| | | shall be set to “1” if the measurement shall be | | | | | |
| | | paused (inactive). The measurement shall be | | | | | |
| | | performed (active) if the bit is set to “0” or if | | | | | |
| | | the Measurement Information IE is not present | | | | | |
| | | in the Create URR IE. | | | | | |
| | | Reduced Application Detection | — | X | — | X | |
| | | Information Flag: this flag may be set to “1”, if | | | | | |
| | | the Reporting Triggers request to report the | | | | | |
| | | start or stop of application, to request the UP | | | | | |
| | | function to only report the Application ID in the | | | | | |
| | | Application Detection Information, e.g. for | | | | | |
| | | envelope reporting. | | | | | |
| | | Immediate Start Time Metering Flag: | — | X | X | X | |
| | | this flag may be set to “1” if time-based | | | | | |
| | | measurement is used and the UP function is | | | | | |
| | | requested to start the time metering | | | | | |
| | | immediately at receiving the flag. . . | | | | | |
| | | Measurement of Number of Packets | X | X | X | X | |
| | | Flag: this flag may be set to “1” when the | | | | | |
| | | Volume-based measurement applies, to request | | | | | |
| | | the UP function to report the number of packets | | | | | |
| | | in UL/DL/Total in addition to the measurement | | | | | |
| | | in octet. | | | | | |
| | | TLS Error Detection Information Flag: | — | X | — | X | |
| | | this flag may be set to “1”, if the | | | | | |
| | | Reporting Triggers request to report the | | | | | |
| | | start or stop of application, and | | | | | |
| | | specifically to request the UP function to | | | | | |
| | | report TLS error information in the | | | | | |
| | | Application Detection Information | | | | | |

Modified version of Table 7.5.4.4-1 from 3GPP TS 29.244:
Update URR IE within PFCP Session Modification Request

| | | | | | | | |
|---|---|---|---|---|---|---|---|
| Measurement | C | This IE shall be included if any of the | — | X | X | X | Measurement |
| Information | | following flag is set to “1”. | | | | | Information |
| | | Applicable flags are: | | | | | |
| | | Measurement Before QoS | — | X | X | X | |
| | | Enforcement Flag: this flag shall be set to | | | | | |
| | | “1” if the traffic usage before any QoS | | | | | |
| | | Enforcement is requested to be measured. | | | | | |
| | | Inactive Measurement Flag: this | — | X | — | X | |
| | | flag shall be set to “1” if the measurement | | | | | |
| | | shall be paused (inactive). The | | | | | |
| | | measurement shall be performed (active) | | | | | |
| | | if the bit is set to “0” or if the | | | | | |
| | | Measurement Information IE is not | | | | | |
| | | present in the Create URR IE. | | | | | |
| | | Reduced Application Detection | — | X | — | X | |
| | | Information Flag: this flag may be set to | | | | | |
| | | “1”, if the Reporting Triggers request to | | | | | |
| | | report the start or stop of application, to | | | | | |
| | | request the UP function to only report the | | | | | |
| | | Application ID in the Application Detection | | | | | |
| | | Information, e.g. for envelope reporting. | | | | | |
| | | Immediate Start Time Metering | — | X | X | X | |
| | | Flag: this flag may be set to “1” if time- | | | | | |
| | | based measurement is used and the UP | | | | | |
| | | function is requested to start the time | | | | | |
| | | metering immediately at receiving the flag. . . | | | | | |
| | | Measurement of Number of | X | X | X | X | |
| | | Packets Flag: this flag may be set to “1” | | | | | |
| | | when the Volume-based measurement | | | | | |
| | | applies, to request the UP function to | | | | | |
| | | report the number of packets in | | | | | |
| | | UL/DL/Total in addition to the | | | | | |
| | | measurement in octet. | | | | | |
| | | TLS Error Detection Information | — | X | — | X | |
| | | Flag: this flag may be set to “1”, if | | | | | |
| | | the Reporting Triggers request to | | | | | |
| | | report the start or stop of application, | | | | | |
| | | and specifically to request the UP | | | | | |
| | | function to report TLS error | | | | | |
| | | information in the Application | | | | | |
| | | Detection Information | | | | | |

The UPF 502 answers the SMF 500 with a PFCP Session Establishment Response indicating successful operation (step 508).

The WCD 310 (e.g., the DNS client 316) decides that DNS re-initialization is needed (step 510) and sends a specific TLS error message in the existing TLS connection between the DNS client 316 and the DNS resolver 314 (step 512). The DNS client 316 may decide that DNS re-initialization is needed when a “bad_certificate” error occurs in step 408 or 412 of FIG. 4 or if establishment of the subsequent, additional TLS session in step 420 fails (see step 424).

The UPF 502 detects the TLS error message in the existing TLS connection between the DNS client 1016 and the DNS resolver 1014 based on the configured PDR and URR from step 506 (step 514) and reports the TLS error to the SMF 500 in a PFCP Session Report Request message (step 516). In one embodiment, the SMF 500 reports the detected TLS error in the PFCP Session Report Request message by extending the Application Detection Information IE as follows:

The proposed solution includes the following impacts (in bold) in the current 3GPP TS 29.244:

Modified version of Table 7.5.8.3-2 from 3GPP TS 29.244: Application
Detection Information IE within Usage Report IE

| Octet 1 and 2 | Application Detection Information IE Type = 68 (decimal) | | | | | | |
|---|---|---|---|---|---|---|---|
| Octets 3 and 4 | Length = n | | | | | | |
| Information | | | Appl. | | | | |
| elements | P | Condition / Comment | Sxa | Sxb | Sxc | N4 | IE Type |
| Application | M | This IE shall identify the Application ID | — | X | X | X | Application |
| ID | | for which a start or stop of traffic is | | | | | ID |
| | | reported. | | | | | |
| Application | C | When present, this IE shall identify the | — | X | X | X | Application |
| Instance ID | | Application Instance Identifier for | | | | | Instance ID |
| | | which a start or stop of traffic is | | | | | |
| | | reported. It shall be present, when | | | | | |
| | | reporting the start of an application, if | | | | | |
| | | the Reduced Application Detection | | | | | |
| | | Information flag was not set in the | | | | | |
| | | Measurement Information and if the | | | | | |
| | | flow information for the detected | | | | | |
| | | application is deducible. It shall be | | | | | |
| | | present, when reporting the stop of an | | | | | |
| | | application, if the Reduced Application | | | | | |
| | | Detection Information flag was not set | | | | | |
| | | in the Measurement Information and if | | | | | |
| | | it was provided when reporting the | | | | | |
| | | start of the application. | | | | | |
| Flow | C | When present, this IE shall contain the | — | X | X | X | Flow |
| Information | | flow information for the detected | | | | | Information |
| | | application. It shall be present, when | | | | | |
| | | reporting the start of an application, if | | | | | |
| | | the Reduced Application Detection | | | | | |
| | | Information flag was not set in the | | | | | |
| | | Measurement Information and if the | | | | | |
| | | flow information for the detected | | | | | |
| | | application is deducible. | | | | | |
| PDR ID | O | When present, it shall contain the PDR | — | X | X | X | PDR ID |
| | | ID which the application traffic | | | | | |
| | | matches. | | | | | |
| Application | O | When present, this IE shall | — | X | X | X | Application |
| Information | | contain application specific | | | | | Information |
| | | information, specifically detection | | | | | |
| | | of a TLS error related to re- | | | | | |
| | | initialization of DNS parameters. | | | | | |
| | | It shall be present, when | | | | | |
| | | reporting the start of an | | | | | |
| | | application, if the Reduced | | | | | |
| | | Application Detection Information | | | | | |
| | | flag was not set in the | | | | | |
| | | Measurement Information and if | | | | | |
| | | the TLS Error Detection | | | | | |
| | | Information flag is enabled in the | | | | | |
| | | corresponding URR. | | | | | |

The SMF 500 answers the UPF 502 with a PFCP Session Report Response indicating successful operation (step 518).

Based on the above report, the SMF 500 triggers a (SMF requested) PDU Session Modification procedure including an extended Protocol Configuration Options (ePCO) Information Element (IE) with the configuration parameters related to DNS resolution (also referred to herein as “DNS parameters) (step 520). In order to do this, the SMF 5000 triggers, towards a corresponding AMF 522, a Namf_Communication_N1N2_MessageTransfer message (step 524) including the following parameters:
N1 SM container, including:
   PDU Session Modification Command, including at least:
      PDU Session ID
      ePCO, including the DNS parameters.
         The AMF 522 answers the SMF 500 with a response message indicating successful operation (step 526).

The AMF 522 forwards the information received from the SMF 500 in step 524 towards the (R)AN (e.g., towards the base station 302) by including this information in the N1N2_MessageTransfer message (step 528). The (R)AN (e.g., base station 302) answers with a response indicating successful operation (step 530).

As only N1 SM container is received in step 528 from the AMF 522, the (R)AN (e.g., base station 302) transports only the N1 SM container to the WCD 310 (step 532). The N1 SM container includes the PDU Session Modification Command, which includes at least the PDU Session ID and the ePCO including the DNS parameters. The WCD 310 answers with a response indicating successful operation (step 534). The WCD 310 stores (re-initializes) the DNS parameters (step 536).

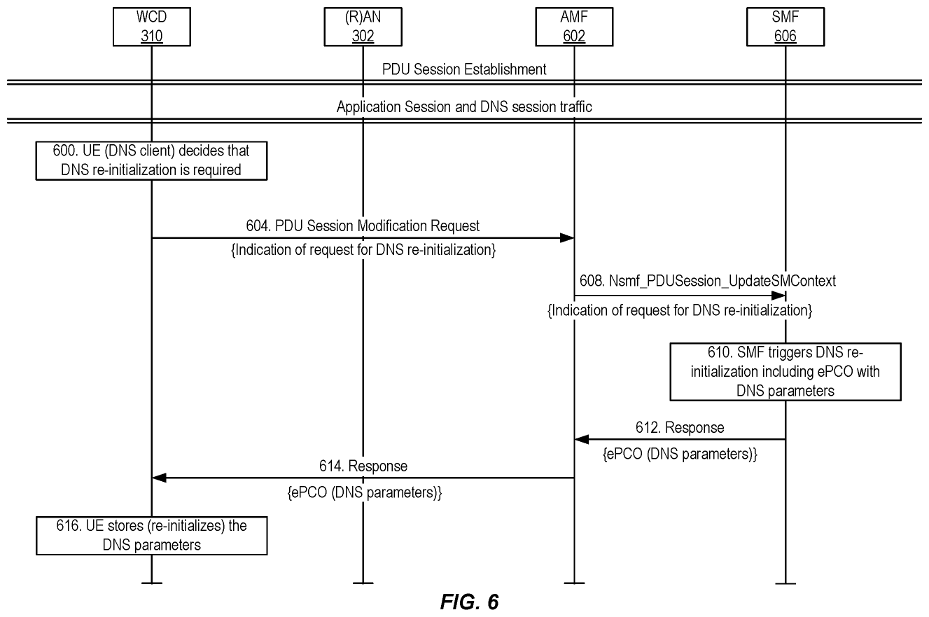

FIG. 6 illustrates an alternative procedure to that of FIG. 5 where, instead of the DNS client 316 triggering a TLS error message, the DNS client 316 (at WCD Operating System (OS) or at WCD Application client) requests a modem of the WCD to trigger a UE Initiated PDU Session Modification procedure to thereby indicate to the network to re-initialize the DNS parameters. More specifically, as illustrated in FIG. 6, the WCD 310 (e.g., the DNS client 316) decides that DNS re-initialization is needed (step 600) and sends PDU Session Modification Request message including an indication of a request for DNS parameter re-initialization to the respective AMF 602 (step 604). The DNS client 316 may decide that DNS re-initialization is needed when a “bad_certificate” error occurs in step 408 or 412 of FIG. 4 or if establishment of the subsequent, additional TLS session in step 420 fails (see step 424). The AMF 602 sends a Nsmf_PDUSession_UpdateSMContext message including an indication of the request to re-initialize the DNS parameters to a respective SMF 606 (step 608). In response, the SMF 606 triggers DNS parameter re-initialization by sending a response to the AMF 602 that includes ePCO including the DNS parameters (steps 610 and 612). The AMF 602 then sends a response to the request of step 604 to the WCD 310, where this response includes the ePCO including the DNS parameters (step 614). The WCD 310 stores (re-initializes) the DNS parameters (step 616).

Note that the embodiments described herein related to the 5GS 300 are only an example. Similar procedures can be applied in an EPS by replacing:
PCF by PCRF
AMF by MME
SMF by PGW-C or TDF-C
UPF by PGW-U or TDF-U.

Now, returning to FIG. 4, assuming that TLS authentication was successful, in one embodiment, one or more additional TLS sessions between the DNS client 316 and the DNS resolver 314 for the same PDU session may subsequently be desired. In one embodiment, in order to establish an additional TLS session for the same PDU session, rather than using the configuration parameters, the DNS client 316 utilizes a session resumption mechanism defined in, e.g., TLS 1.3 based on a Pre-Shared Key (PSK) or PSK-ECDHE authentication to setup the additional TLS session, as described above with respect to step 216 of FIG. 2. As understood by those of skill in the art, the PSK or PSK-ECDHE is obtained during setup of the initial TLS session above and is used for TLS authentication during a modified TLS handshake (i.e., a TLS handshake for session resumption). Because this secret is obtained during the initial TLS session setup, TLS authentication for the additional TLS session will only succeed if the server application 112 is the same as that to which the initial TLS session was established. Otherwise, TLS authentication will fail, and a TLS error will be detected, which in turn will trigger a TLS error report to the network 102 and a network-triggered re-configuration of the configuration parameters for TLS session setup.

Further details regarding establishment of such a subsequent TLS session will now be described. Using the existing solution, when establishing a subsequent TLS session, the stored configuration parameters on the WCD 310 are read and used to initiate the TLS session. One problem is that stored configuration parameters on the WCD 310 have limited guarantees of integrity, and one should refrain from relying on these stored configuration parameters. In order to address this problem as well as to address the problem of ensuring that such subsequent TLS sessions are established to the same (legitimate) DNS resolver 314 as the initial TLS session, in some embodiments, one of the two following mechanisms are used to establish the subsequent TLS session. The first mechanism relies on a TLS 1.3 mechanism known as session resumption based on PSK or PSK-ECDHE authentication. The second mechanism consists of re-doing a TLS handshake using ECDHE authentication. This mechanism assumes that the DNS client 316 supports DNS Security Extensions (DNSSEC), the TLS identity pining extension.

When the DNS client 316 determines that a TLS session to be established not the initial TLS session for the associated PDU session (e.g., determines that the TLS session is not initiated while negotiating a PDU session), the DNS client 316 considers using session resumption where authentication is based on PSK(-ECDHE) authentication with a PSK that is derived from a secret derived in the previous TLS handshake when establishing the initial TLS session. PSK and NewSessionTickets (see, e.g., RFC8446) are of course also stored on the WCD 310, but this information is expected to be managed and access solely by the TLS library and so be associated to a higher level of security. In addition, the TLS handshake using PSK based authentication are 1-Round Trip Time (RTT) and are also expected to be lighter, so the additional security also comes with an additional performance gain.

Identity pinning or DNSSEC validation not supported: In one embodiment, it is assumed that:
The DNS client 316 does not support DNSSEC validation, or identity pinning (see, e.g., RFC8672) is not supported by the DNS client 316 or by the DNS resolver 314.
The DNS client 316 and the DNS resolver 314 support TLS session resumption.
   In one embodiment, when the DNS client 316 needs to set a new TLS session with the DNS resolver 314, the DNS client 316 proceeds to a session resumption. If the DNS client 316 does not have NewSessionTicket available, a proactive DNS client MAY trigger a procedure to re-initialize the DNS parameters that were initially set for the PDU session. If the DNS client 316 does not provide valid NewSessionTickets, the network normally must trigger a procedure to re-initialize the DNS parameters. Note that the TLS server can in principle always fall back to ECDHE. In our case the TLS server (i.e., the DNS resolver 314) must not do this unless TLS identity pinning is supported. The TLS session is instead aborted by the DNS client 316 and a re-initialization procedure is triggered. Note that in this case, the legitimate DNS resolver is not expected to use ECDHE, and the response is expected to come from an attacker. It is important this detection be performed and resolved by the DNS client 316 as it cannot be detected by the legitimate DNS resolver. Such situation may also be prevented via other means-like preventing any changes on the identity. Note also that the DNS resolver 314 is expected to maintain a log of the first TLS session. This is performed by the network providing the authorized IP addresses (from the UE), and these IP addresses are removed after the first TLS session establishment. Similarly, in one embodiment, a DNS resolver proposing ECDHE authentication to the DNS client 316 must be logged and the session must consider this as an attack. The DNS client 316 may trigger a procedure to re-initialize the DNS parameters that were initially set for the PDU session.

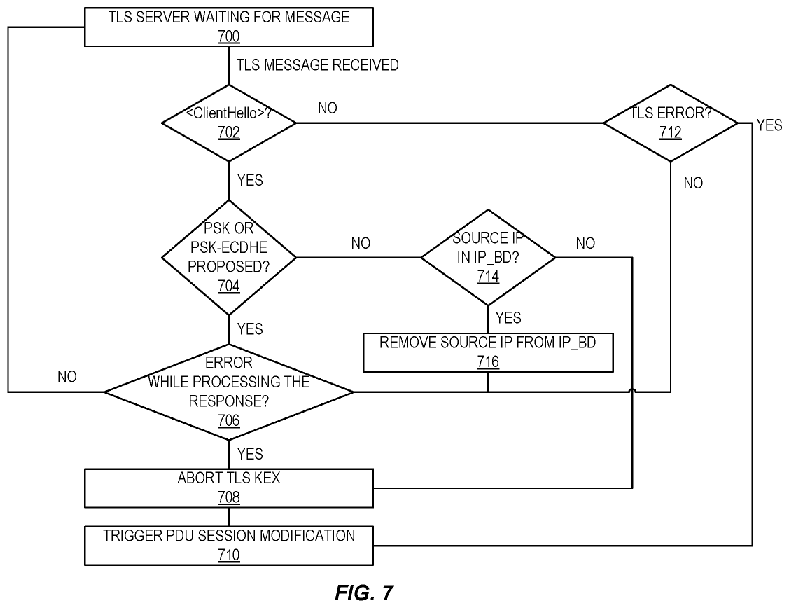

FIG. 7 is a flow chart that illustrates the operation of the DNS resolver 314 in accordance with one example embodiment of the present disclosure. As illustrated, a TLS server of the DNS resolver 314 waits for a TLS message (step 700). Upon receipt of a TLS message, the TLS server of the DNS resolver 314 determines whether the received TLS message is a <ClientHello> message (step 702). If so, the TLS server of the DNS resolver 314 determines whether PSK or PSK-ECDHE is proposed (step 704). If so, the TLS server of the DNS resolver 314 determines whether there is an error while processing the response (step 706). If so, the TLS server of the DNS resolver 314 aborts the TLS KEX (step 708) and triggers a PDU Session Modification (step 710).

Returning to step 702, if the message is not a <ClientHello> message (step 702, NO), the TLS server of the DNS resolver 314 determines whether the received TLS message is indicative of a TLS error (step 712). If so, the process proceeds to step 710 to trigger a PDU session modification. Otherwise, the process proceeds to step 706.

Returning to step 704, if the received message is a <ClientHello> message and PSK or PSK-ECDHE is not proposed, the TLS server of the DNS resolver 314 determines whether a source IP of the received TLS message is in IP_DB (step 714). IP_DB is a database provisioned with assigned IP addresses (i.e., IP addressed assigned for PDU sessions). If so, the source IP is removed from IP_DB (step 716) and the process proceeds to step 706. Otherwise, the process proceeds to step 708.

Identity pinning and DNSSEC validation supported: In one embodiment, it is assumed that:
the DNS client 316 supports DNSSEC validation, and
identity pinning [RFC8672] is supported by the DNS client 316 and by the DNS resolver 314 and has been activated during the first TLS session.
   Note also that identity pinning can be seen as a second factor authentication and so the necessary material to set the TLS session using ECDHE authentication remain needed. The DNS client 316 may proceed or accept an ECDHE authentication and proceed as follows. If the DNS client 316 finds the identity being pinned, the DNS client 316 should retrieve the TLSA RRset via a DNS request specially to get the potentially new value of the certificate hash. In order to retrieve this value, the DNS client 316 must support DNSSEC and authenticate the RRsets. The request is performed doing a <ip_address>.in-addr.arpa TLSA eventually via some indirection via specific DNS RRsets such as CNAME, PTR, etc. The TLS session can be established to the IP address and port. The port may not be a default port that characterizes the type of security. It is recommended that the DNS client 316 and the DNS resolver 314 supports the TLS ALPN extension to agree the protocol being used. If the negotiated protocol is not supported by the DNS client 316, this should be considered as an attack and the DNS parameters must be re-initialized.

FIG. 8 is a schematic block diagram of a network node 800 according to some embodiments of the present disclosure. Optional features are represented by dashed boxes. The network node 800 may be, for example, an embodiment of the network node 104, 110, 308, or 312. The network node 800 may also be, for example, an embodiment of a core network node that implements a NF (e.g., SMF 500, UPF 502, AMF 522, AMF 602, or SMF 606) or a network node that implements all or part of the functionality of an NF (e.g., all or part of the functionality of the network node 104, 110, 308, or 312 or the SMF 500, UPF 502, AMF 522, AMF 602, or SMF 606 described herein). As illustrated, the network node 800 includes a one or more processors 804 (e.g., Central Processing Units (CPUs), Application Specific Integrated Circuits (ASICs), Field Programmable Gate Arrays (FPGAs), and/or the like), memory 806, and a network interface 808. The one or more processors 804 are also referred to herein as processing circuitry. The one or more processors 804 operate to provide one or more functions of the network node 800 as described herein (e.g., all or part of the functionality of the network node 104, 110, 308, or 312 or the SMF 500, UPF 502, AMF 522, AMF 602, or SMF 606 described herein). In some embodiments, the function(s) are implemented in software that is stored, e.g., in the memory 806 and executed by the one or more processors 804.

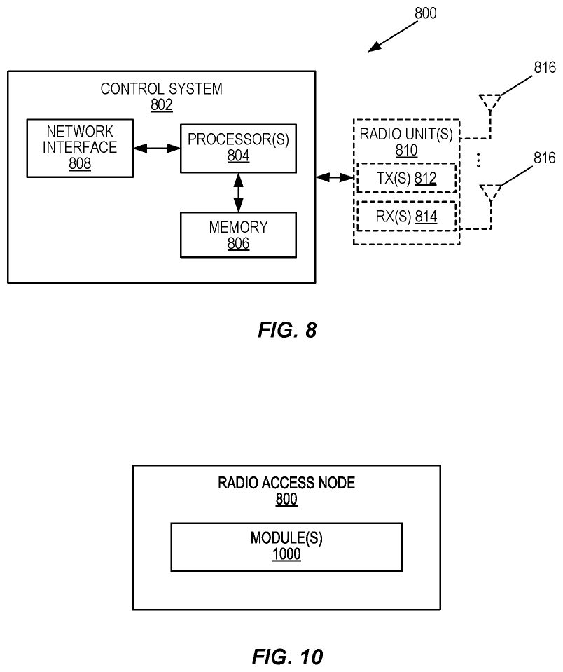

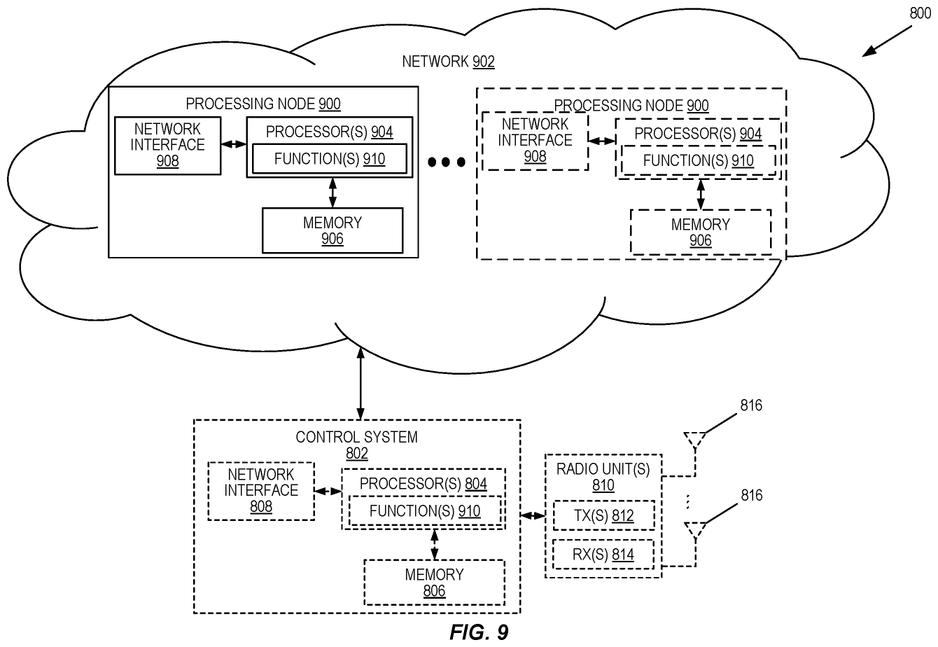

FIG. 9 is a schematic block diagram that illustrates a virtualized embodiment of the network node 800 according to some embodiments of the present disclosure. Again, optional features are represented by dashed boxes. As used herein, a “virtualized” network node is an implementation of the network node 800 in which at least a portion of the functionality of the network node 800 is implemented as a virtual component(s) (e.g., via a virtual machine(s) executing on a physical processing node(s) in a network(s)). As illustrated, in this example, the network node 800 includes one or more processing nodes 900 coupled to or included as part of a network(s) 902. Each processing node 900 includes one or more processors 904 (e.g., CPUs, ASICs, FPGAS, and/or the like), memory 906, and a network interface 908. In this example, functions 910 of the network node 800 described herein (e.g., all or part of the functionality of the network node 104, 110, 308, or 312 or the SMF 500, UPF 502, AMF 522, AMF 602, or SMF 606 described herein) are implemented at the one or more processing nodes 900 or distributed across the two or more processing nodes 900 in any desired manner. In some particular embodiments, some or all of the functions 910 of the network node 800 described herein are implemented as virtual components executed by one or more virtual machines implemented in a virtual environment(s) hosted by the processing node(s) 900.

In some embodiments, a computer program including instructions which, when executed by at least one processor, causes the at least one processor to carry out the functionality of the network node 800 or a node (e.g., a processing node 900) implementing one or more of the functions 910 of the network node 800 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 10 is a schematic block diagram of the network node 800 according to some other embodiments of the present disclosure. The network node 800 includes one or more modules 1000, each of which is implemented in software. The module(s) 1000 provide the functionality of the network node 800 described herein. This discussion is equally applicable to the processing node 900 of FIG. 9 where the modules 1000 may be implemented at one of the processing nodes 900 or distributed across multiple processing nodes 900.

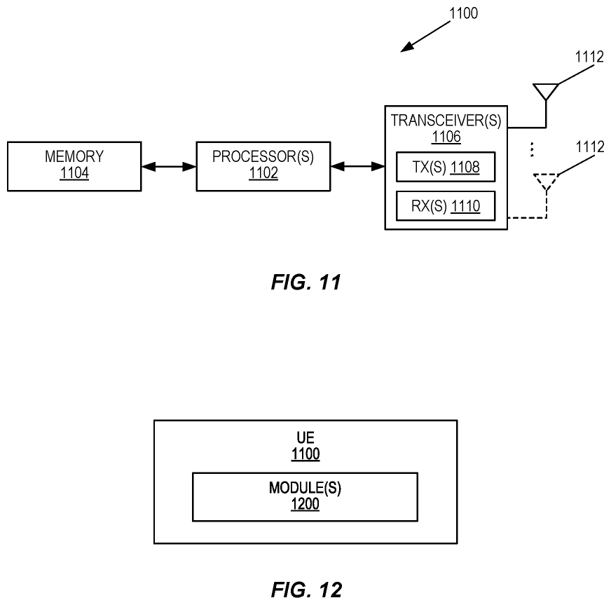

FIG. 11 is a schematic block diagram of a wireless communication device 1100 (e.g., WCD 310) according to some embodiments of the present disclosure. Note that the communication device 106 may have a similar architecture but have either a wired or wireless network interface rather than the transceivers illustrated in FIG. 11. As illustrated, the wireless communication device 1100 includes one or more processors 1102 (e.g., CPUs, ASICS, FPGAS, and/or the like), memory 1104, and one or more transceivers 1106 each including one or more transmitters 1108 and one or more receivers 1110 coupled to one or more antennas 1112. The transceiver(s) 1106 includes radio-front end circuitry connected to the antenna(s) 1112 that is configured to condition signals communicated between the antenna(s) 1112 and the processor(s) 1102, as will be appreciated by on of ordinary skill in the art. The processors 1102 are also referred to herein as processing circuitry. The transceivers 1106 are also referred to herein as radio circuitry. In some embodiments, the functionality of the wireless communication device 1100 described above may be fully or partially implemented in software that is, e.g., stored in the memory 1104 and executed by the processor(s) 1102. Note that the wireless communication device 1100 may include additional components not illustrated in FIG. 11 such as, e.g., one or more user interface components (e.g., an input/output interface including a display, buttons, a touch screen, a microphone, a speaker(s), and/or the like and/or any other components for allowing input of information into the wireless communication device 1100 and/or allowing output of information from the wireless communication device 1100), a power supply (e.g., a battery and associated power circuitry), etc.

In some embodiments, a computer program including instructions which, when executed by at least one processor, causes the at least one processor to carry out the functionality of the wireless communication device 1100 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the wireless communication device 1100 according to some other embodiments of the present disclosure. The wireless communication device 1100 includes one or more modules 1200, each of which is implemented in software. The module(s) 1200 provide the functionality of the wireless communication device 1100 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a client application, comprising:
obtaining one or more configuration parameters for establishing a Transport Layer Security, TLS, session between the client application and a trusted server application, the one or more configuration parameters comprising either:
a certificate of the trusted server application,
a hash of the certificate of the trusted server application, or
a Pre-Shared Key, PSK;
performing a TLS handshake procedure with a server application, wherein either:
during the TLS handshake procedure the client application receives a certificate from the server application, or
the TLS handshake procedure is performed with PSK authentication based on the PSK comprised in the one or more configuration parameters;
determining that an error has occurred based on either:
a comparison of either: (i) the certificate of the trusted server application comprised in the one or more configuration parameters and the certificate received from the server application during the TLS handshake or (ii) the hash of the certificate of the trusted server application and a computed hash of the certificate received from the server application during the TLS handshake; or
failed PSK authentication; and
responsive to determining that the error has occurred, performing one or more actions that directly or indirectly trigger reinitialization of the one or more configuration parameters.

2. The method of claim 1 wherein:
the one or more configuration parameters comprise the hash of the certificate of the trusted server application;
the method further comprises computing a hash of the certificate received from the server application during the TLS handshake; and
determining that the error has occurred comprises:
comparing the hash of the certificate of the trusted server application comprised in the one or more configuration parameters and the hash of the received certificate; and
determining that there is an error based on a result of comparing the hash of the certificate of the trusted server application comprised in the one or more configuration parameters and the hash of the received certificate.

3. The method of claim 2 wherein the one or more configuration parameters comprise an Internet Protocol, IP, address associated to the trusted server application, an indication of a security protocol type, and a TLS for Authentication record, TLSA, that contains the hash of the certificate of the trusted server application.

4. The method of claim 3 wherein the one or more configuration parameters further comprise a port number.

5. The method of claim 3 wherein the one or more configuration parameters further comprise an authentication domain name.

6. The method of claim 1 further comprising, responsive to determining that the error has occurred, aborting setup of the TLS session.

7. The method of claim 1 wherein performing one or more actions that directly or indirectly trigger reinitialization of the one or more configuration parameters comprises reporting a TLS error to a network node.

8. The method of claim 7 further comprising, responsive to reporting a TLS error to a network node, receiving a message comprising one or more re-initialized configuration parameters for establishing a TLS session between the client application and a trusted server application.

9. The method of claim 1 wherein performing one or more actions that directly or indirectly trigger reinitialization of the one or more configuration parameters comprises sending, to a network node, a message for modification of the IP connectivity session that comprises an indication of a request for re-initialization of the one or more configuration parameters for establishing a TLS session between the client application and a trusted server application.

10. The method of claim 1 wherein the client application is a Domain Name System, DNS, client, and the server application is a DNS resolver.

11. The method of claim 1 wherein the client application is implemented on a wireless communication device for a cellular communications system, and obtaining the one or more configuration parameters comprises obtaining the one or more configuration parameters from a network node in a core network of the cellular communications system.

12. The method of claim 11 wherein the cellular communication system is either a Fifth Generation System, 5GS, or an Evolved Packet System, EPS.

13. A communication device that includes a client application, the communication device comprising processing circuitry configured to cause the communication device to:
obtain one or more configuration parameters for establishing a Transport Layer Security, TLS, session between the client application and a trusted server application, the one or more configuration parameters comprising either: a certificate of the trusted server application, a hash of the certificate of the trusted server application, or a Pre-Shared Key, PSK; and
execute the client application such that the client application:
performs a TLS handshake procedure with a server application, wherein either:
during the TLS handshake procedure, the client application receives a certificate from the server application; or
the TLS handshake procedure is performed with PSK authentication based on the PSK comprised in the one or more configuration parameters;
determine that an error has occurred based on either:
a comparison of either: (i) the certificate of the trusted server application comprised in the one or more configuration parameters and the certificate received from the server application during the TLS handshake or (ii) the hash of the certificate of the trusted server application and a computed hash of the certificate received from the server application during the TLS handshake; or
failed PSK authentication; and
responsive to determining that the error has occurred, perform one or more actions that directly or indirectly trigger reinitialization of the one or more configuration parameters.

14. (canceled)

15. A method performed by a client application, comprising:
obtaining one or more configuration parameters for establishing a Transport Layer Security, TLS, session between the client application and a trusted server application, the one or more configuration parameters comprising either: (a) a certificate of the trusted server application or (b) a hash of the certificate of the trusted server application;
performing a TLS handshake procedure with a server application during which the client application receives a certificate from the server application;
determining that the server application from which the certificate is received during the TLS handshake is the trusted server application based on a comparison of either: (i) the certificate of the trusted server application comprised in the one or more configuration parameters and the certificate received from the server application during the TLS handshake or (ii) the hash of the certificate of the trusted server application and a computed hash of the certificate received from the server application during the TLS handshake;
responsive to determining that the server application from which the certificate is received during the TLS handshake is the trusted server application, proceeding with setup of the TLS session; and
performing a TLS handshake for establishment of a subsequent TLS session associated to the same IP connectivity session using a mechanism that ensures that the subsequent TLS session is established to the same trusted server application at that to which the TLS session is established.

16. The method of claim 15 wherein the mechanism is either TLS session resumption based on a Pre-Shared Key, PSK, or PSK Elliptic-Curve Diffie-Hellman Exchange, PSK-ECDHE, authentication or a TLS handshake using Elliptic-Curve Diffie-Hellman Exchange, ECDHE, authentication.

17. A method performed by a first network node in a core network of a cellular communications system, the method comprising:
receiving, from a second network node, a message that comprises one or more rules to be implemented by the first network node to detect a Transport Layer Security, TLS, error reported by a wireless communication device within traffic for an existing TLS connection between a Domain Name System, DNS, client at the wireless communication device and a DNS resolver;
detecting a TLS error reported by the wireless communication device using the one or more rules;
responsive to detecting the TLS error, sending a message to the second network node that comprises an indication of a request to re-initialize one or more DNS parameters configured to the wireless communication device.

18. The method of claim 17 wherein:
the cellular communications system is a Fifth Generation System, 5GS;
the first network node is a User Plane Function, UPF;
the second network node is a Session Management Function, SMF;
receiving the message that comprises the one or more rules comprises receiving, from the SMF, a Packet Forwarding Control Protocol, PFCP, Session Establishment Request comprising the one or more rules; and
sending the message comprises sending a PFCP report request message to the SMF, wherein the PFCP report request message comprises the indication of the request to re-initialize the one or more DNS parameters configured to the wireless communication device.

19. (canceled)

20. (canceled)

21. (canceled)
